(19) United States
(12) Patent Application Publication
(10) Pub. No.: US 2025/0278946 A1
(43) Pub. Date: Sep. 4, 2025

(54) TRAVEL LANE ELEMENT CLASSIFICATION

(71) Applicant: AUTOBRAINS TECHNOLOGIES LTD, Tel Aviv-Yafo (IL)

(72) Inventors: Igal Raichelgauz, Tel Aviv (IL); Shay Leizerovitch, Mikhmoret (IL)

(73) Assignee: AUTOBRAINS TECHNOLOGIES LTD, Tel Aviv-Yafo (IL)

(21) Appl. No.: 18/595,381

(22) Filed: Mar. 4, 2024

Related U.S. Application Data
(63) Continuation of application No. 18/595,368, filed on Mar. 4, 2024.

(51) Int. Cl. G06V 20/56; G06V 10/762; G06V 10/764

(52) U.S. Cl. CPC G06V 20/588; G06V 10/762; G06V 10/764

(57) ABSTRACT

A method for travel lane element classification, including obtaining, via a processing circuit, information indicative of a travel lane including one or more travel lane elements located within an environment of a vehicle; generating a plurality of keypoints from the information; organizing the plurality of keypoints into one or more subgroups of keypoints, wherein each of the one or more subgroup of keypoints is indicative of one or more categories of travel lane elements; generating one or more embeddings of the one or more subgroup of keypoints, and classifying, based on the one or more embeddings, the one or more organized subgroup of keypoints as indicative of a travel lane marker. The classifying triggers a determination of a driving related operation to be executed by the vehicle.

### BACKGROUND

Assisted and autonomous driving systems are known in the art. In such systems, computer implemented systems control (at least to some extent) some, or all, of a vehicle's driving functions, e.g., speed, telemetry, braking, etc. The vehicle is typically equipped with one or more sensors to provide the system with current information regarding the driving environment. The current information for the driving environment is typically used by the driving system to determine how to drive on roadways.

Object and road feature detection plays a key role in assisted and autonomous vehicle driving systems.

### SUMMARY

A method, system and non-transitory computer readable medium as illustrated in the application.

### A BRIEF DESCRIPTION OF THE DRAWINGS

The embodiments of the disclosure will be understood and appreciated more fully from the following detailed description, taken in conjunction with the drawings in which:

FIG. 1 illustrates an example of a system according to embodiments of the disclosure;

FIG. 2 illustrates an example of transforming a sensed information unit to a representative embedding according to embodiments of the disclosure;

FIG. 3 illustrates an example of mapping a sensed information unit to cluster of representative embeddings according to embodiments of the disclosure;

FIG. 4 illustrates an example of identifying and processing sensed travel lane features according to embodiments of the disclosure;

FIG. 5 is a flow diagram of a method for object detection and classification according to embodiments of the disclosure;

FIG. 6 is a flow diagram of a method for travel lane feature detection and classification according to embodiments of the disclosure;

FIG. 7 is a block diagram of a computer according to an aspect of the present disclosure;

FIG. 8 is an example of a method;

FIG. 9 is an example of an image and various information elements;

FIG. 10 is an example of an image, keypoints and a cropped image;

FIG. 11 is an example of an image, a cropped image and various information elements;

FIG. 12 is an example of a method;

FIG. 13 is an example of images and a cropped images;

FIG. 14 is an example of an image, cropped images, a first neural network, various units and various information elements; and

FIG. 15 is an example of a method.

### DETAILED DESCRIPTION

### Object Detection

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Systems and methods of the present disclosure relate to the detection and classification of objects and other characteristics for object detection, travel lane feature recognition, sign recognition, etc. In the context of autonomous driving an input into the system may be a cropped image including sensed information relating to, for instance, a particular object of interest only, with background information (i.e., environmental context) removed or cropped out. Separate embedding vectors may be generated for each corresponding cropped image input.

Systems and methods described herein may be configured to insert similar cropped images clustering to the crop to vector network, in operation across the representative vector database. The representative vector database may be maintained by the system 100 or by a third party, or by two or more third parties.

It is contemplated that the process of mapping cropped sensed information units to representative vectors in a database may have further applications beyond autonomous driving.

Systems and methods described herein include adding to, replacing, updating, or otherwise manipulating clusters of representative vectors for a given representative class. The manipulation may also be performed on the existing database of vectors. For example, a database may be separated into one or more separate databases.

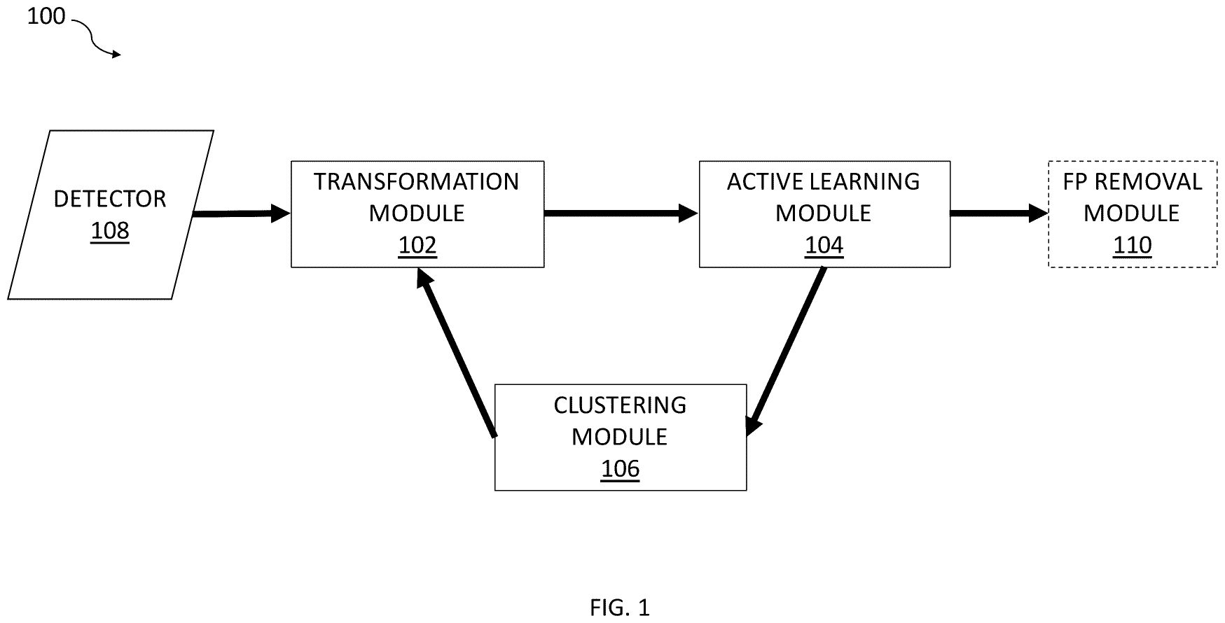

An object detection system 100 is shown in FIG. 1. The object detection system 100 may include a transformation module 102, an active learning module 104 and a clustering module 106.

According to an embodiment, a False Positive removal operation is applied by a False Positive (FP) removal module 110 that may be fed by the output of the transformation module 102 and/or by the output of the active learning module 104.

The transformation module 102 may be configured to received information (e.g., sensed information units) from a detection module, such as detector 108. The detector 108 may be a neural network (i.e., a first-stage neural network). During a first stage, which may occur prior to the transformation module receiving sensed information units (or cropped sensed information units), for a given sensed information unit, the detection module (i.e., a “first stage neural network) may detect one or more objects or features within a field of view. The detected objects or features can be formatted as bounding boxes, segments, etc. For each detection, the sensed information unit may be reduced or cropped by a predetermined amount. The crop may include predefined margins (i.e., image pixel count, dimensions, size, etc.).

The information received by the transformation module 102 may be input into the transformation module 102 from, for instance, the detector 108 of the system 100 or from a third-party system. The information received, for example, from the detector 108 may be any type of sensed information. For instance, the information may be a sensed information unit (e.g., an image), a cropped sensed information unit (e.g., a cropped image), a segment (e.g., an image segment processed using segmentation), a keypoint, or a bounding box. etc. These inputs may be fed into the transformation module 102, which may also be configured as a neural network (i.e., a second stage neural network). Keypoints, for example, may be utilized if the object detection relates to detecting lane characteristics (e.g., lane markers, lane boundaries, road marks, etc.). Bounding boxes may be utilized if the object detection relates to physical objects in a field of view of the vehicle (e.g., pedestrians, landscape, traffic signs, obstructions, etc.). As used herein, segmentation may refer to coloring of an image, as is known in the art.

As mentioned, the input from the detector 108 may be cropped prior to further processing by the transformation module 102. The cropping may occur within the detector 108 or within the transformation module 102. In some instances, the cropping is performed by the detector 108 prior to output. In other instances, the transformation module 102 performs the cropping prior to performing a transformation step on the information (e.g., the sensed information unit).

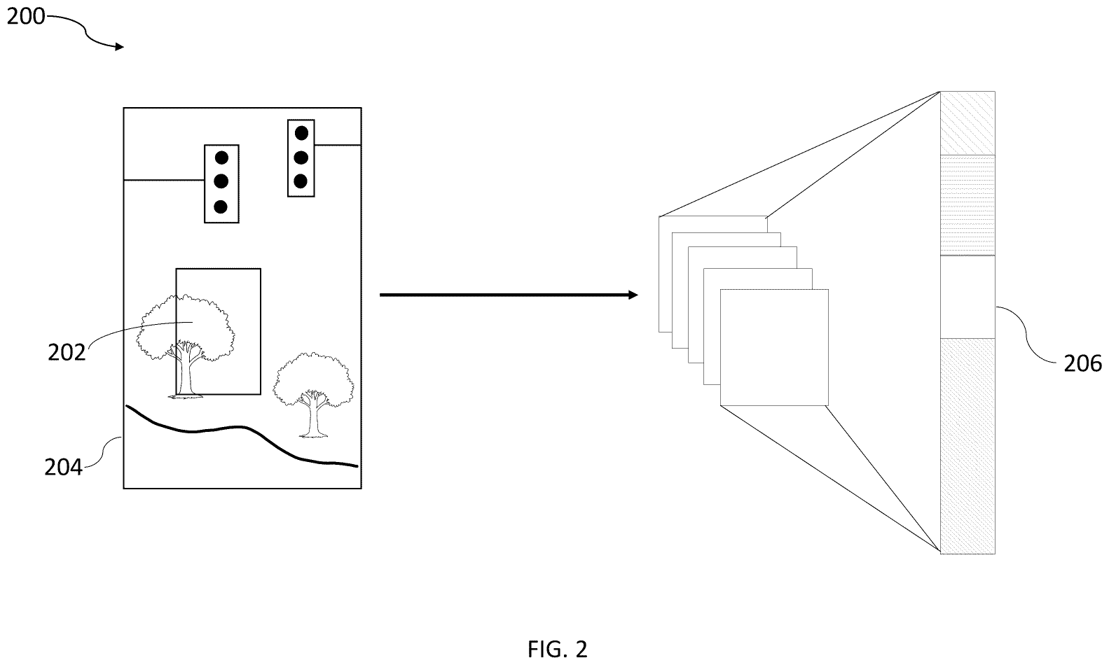

A transformation step may include transforming a cropped sensed information unit into a representative embedding or vector, also otherwise referred to herein as a discriminating feature vector. Sensed information units received by the transformation module 102 may be processed to provide discriminating feature vectors. To accomplish this, the transformation module 102 may be leverage a second-stage neural network to transform the cropped sensed information unit into a representative vector. FIG. 2 illustrates an example 200 of transforming a sensed information unit to a representative embedding according to embodiments of the disclosure. For a given image, the first stage neural network detector yields detections such as bounding boxes, key points, segments, etc. As an example, an object of interest portion 202 may be identified in a detected image 204 within the field of view of a vehicle. The object of interest portion 202 of the detected image 204 may be cropped from the detected image 204, and the cropped portion may be input into the transformation module 102. For each detection, a cropped portion may be extracted from the sensed information unit (e.g., the image) with some predefined margin. The transformation module 102 may then identify characteristics of the object of interest portion 202 and map the identified characteristics into a discriminating feature vector 206. According to embodiments of the disclosure, the transformation module 102 may be configured to map or represent detected objects or features within a sensed information unit as latent space high-dimensional vectors.

Systems and methods according to embodiments of the disclosure are configured to train the first and second stage neural networks to cluster detected objects and features of the same type. The system can separately train the first stage neural network and the second stage neural networks. During training and mapping, the system may then distance formed clusters from one another. The distance between two or more clusters may vary based on the similarities or differences the representing vectors of the clusters, as identified by the system. In this manner, the system is configured to identify the representing vectors (i.e., descriptors) of the one or more clusters. The representing vectors represent clusters of different detections in the latent (or embedding space).

When the transformation module 102 receives or processes a cropped sensed information unit (e.g., a cropped image or other cropped sensed data), the transformation module 102 is configured to map the cropped sensed information unit to an embedding vector. The embedding vectors may be stored in a database and/maintained by the system, by a third party, or one or more groupings of embedding vectors may be stored and/or maintained by two or more third parties (i.e., external to the vehicle and off-board system components described herein and incorporated by reference).

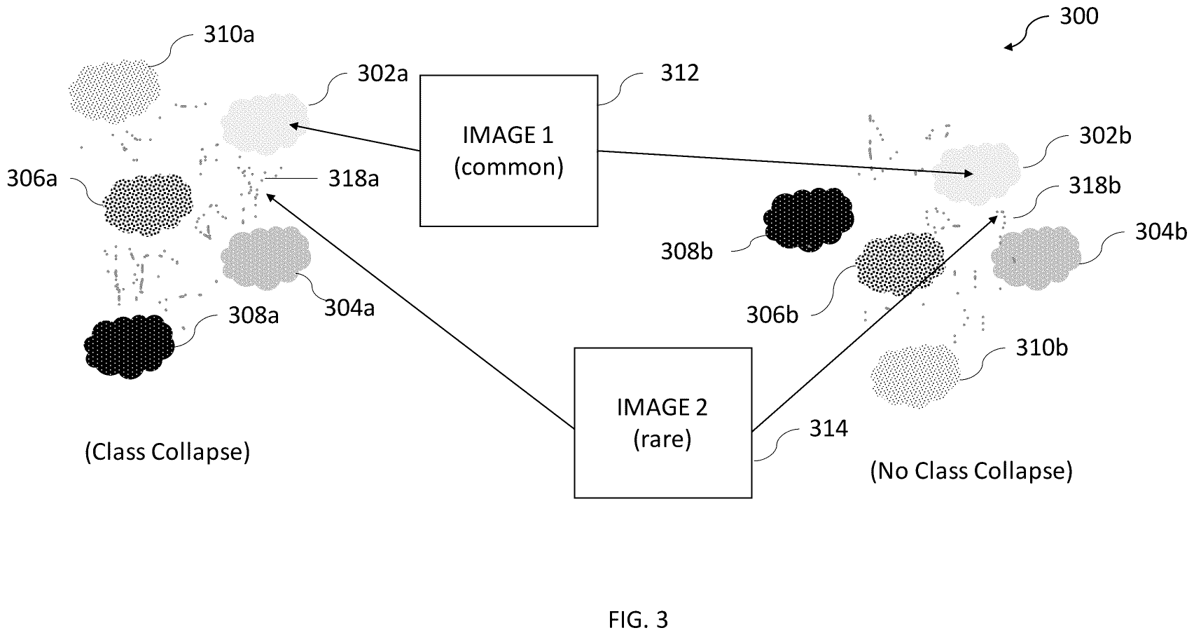

The transformation module 102 is configured to classify a newly generated vector. That is, the new (input) vector is matched to one or more representing vectors or clusters or representing vectors, and, by its similarity to one of the clusters (i.e., concepts), the crop will be classified. In embodiments, contrastive supervised learning may be utilized to map the cropped sensed information unit that is transformed into a discriminating feature vector onto representing vectors. FIG. 3 illustrates an example of mapping a vectorized sensed information unit to cluster of representative embeddings (vectors) according to embodiments of the disclosure. A set of clusters including relevant representative vectors 302a, 304a, 306a, 308a, 310a, 302b, 304b, 306b, 308b, 310b may be accessed by the transformation module 102. A common image 312 (e.g., a clear image of a face or domestic animal) may be confidently mapped to a first cluster 302a, 302b, while a less common image 314 (e.g., a less clear image of a face or animal), may be mapped to a region 318a, 318b between two clusters (e.g., 302a and 304a, and 302b and 304b, respectively) that contain overlapping or adjacent representative vectors. The transformation module 102 is configured to map the cropped sensed information unit to a cluster or, region adjacent to one or more clusters where the available clusters are condensed (e.g., Class Collapse clusters), such that there may be more distance between the clusters and the representative vectors are closer together within each cluster, but longer trails of representative vectors that cannot be definitively collapsed into a single cluster are present. The transformation module 102 is also configured to map the cropped sensed information unit to a cluster, or region adjacent to one or more clusters, where the available clusters are not condensed (e.g., No Class Collapse clusters), such that there may be less distance between the clusters and the representative vectors are farther apart within each cluster, but fewer trails of representative vectors are present between clusters.

Note that the number of representing vectors may vary for different clusters, depending on the cluster's variance and its separation from other clusters. The vectors may be used to build narrow concepts where the classification is dictated by the similarity between the detections' embeddings and the representing vectors (i.e., the cluster to which the detection belongs).

This approach brings several advantages such as addressing issues relating to open vocabulary. For instance, the system may also be configured to remove false detections or false alarms (via, for example, false positive (FP) removal module 110), and/or provide subclassifications for vectors within clusters.

In the case of removing false alarms, for example, false alarm data points may not be able to be defined as belonging to a single class (e.g., cat, dog, person etc.). Thus, attempts to classify the false alarm data as belonging to one or several subclasses may be inaccurate. For instance, the classification will be inaccurate if the system attempts to associate similar detected objects with a single class, when at least one of the objects should be classified separately.

Also, scalability becomes challenging when attempting to properly subclassify all detected objects using, for instance, using manual or semi-automatic sub-labeling. Thus, typically, a generalized neural network requires substantial example inputs to be properly trained. Methods and systems according to embodiments of the invention provide the ability to partially train the neural network using an additive training feature. This additive property of the system enables neural network training with fewer examples, where new sub-clusters may be created and differentiated from existing clusters and sub-clusters.

In the instance where a new detection type is classified and cannot be classified as belonging to an existing cluster, the process may continue without additional training of, for instance, the entire available neural network (which can create an endless cycle of mining new data and training). Instead, the system is configured to add new vectors in the existing embedding space and create sub-clusters from the new vectors.

To accomplish this goal of using relatively fewer examples to train the neural network, the system is configured to dynamically modify different input information (e.g., concepts) in real time. For example, representative concepts may be added to or subtracted from a cluster, and clusters may be split into one or more additional clusters or merged with one or more additional clusters as the neural network further refines the clusters. This addition, subtraction, merging and/or splitting may be effected by identifying similarities and differences in the clusters and determining, at the cluster level, whether an example or detected object should be classified as associated with the cluster.

Embodiments of the disclosure are configured to create global clusters, sub clusters, new clusters etc. To this end, embodiments of the disclosure are configured to dynamically distance distinct clusters and/or remove irrelevant or non-related information (e.g., image information) from a cluster. The non-related information may then be clustered as a new cluster (sub cluster, etc), and mapped to a new (cropped, feature vector) embedding. Clusters may be manipulated or hand crafted, such that relevant representative vectors may be identified and added to a cluster and non-relevant clusters may be removed from a cluster. Existing clusters can be manipulated to add or subtract vectors, reduce the cluster size and/or change the cluster shape as additional information is input into the system. For instance, a cluster may be formed that includes representative vectors of four-wheeled vehicles. Over time, as more inputs relating to four-wheeled vehicles are received by the transformation module 102 and more representative or discriminating feature vectors are created or more examples, concepts or other object information is received via, for instance, a third-party database, the cluster may be modified.

Any semantic changes in the formed cluster may trigger a modification of the cluster, and the cluster may grow, split, or one or more sub-clusters may be formed within the cluster. For instance, as additional feature vectors are identified and mapped to input sensed information units, the four-wheeled vehicle cluster may eventually be split into two or more clusters as additional features of the vectors are classified (e.g., cars, trucks, or subcategories of cars and/or trucks). Each iteration/modification of the one or more clusters improves the object detection and classification capabilities of the system. A cluster hierarchy may also be formed within a cluster. Ultimately, the ever-changing nature of the clusters, as well as the increase and decrease in the distance between clusters, increase confidence in the object detection and classification system.

The discriminating feature vectors may be fed to the active learning module (for generating a corresponding signature) dynamically, on the fly while in production, without the need to retrain the entire network. Embodiments of the disclosure are configured to provide an automated in-house training and handling process. The in-house training may occur during the training of the second stage neural network (i.e., the transformation module 102). For instance, the system is also configured to automatically and dynamically add, edit, modify, remove, etc., an embedding (e.g., a discriminating feature vector) in real time, leading to real-time removal of false positive signatures.

Embodiments of the disclosure are configured to enable partial training of the first and/or second stage neural networks. Therefore, the system is not required to train or retrain the transformation module (i.e., the crop-to-vector neural network). Nor is the system required to train or retrain the entire first stage neural network (i.e., the detector network or a “production network”) with the addition of a new concept, image or other sensed information unit.

Applications of the second stage (e.g., “crop-to-vector”) neural network include general detection during a driving operation (object detection, lane detection, sign recognition, detection and clustering of a new, undefined or otherwise unrecognized road feature, etc.).

Embodiments of the system are configured to process instances involving fringe or edge sensed information units (i.e., an image of a rare object that may share one or more features with objects in cluster, but not enough features to be definitively classified within the cluster). FIG. 3 further illustrates processing of fringe or edge cases. Such capabilities provide effective handling of long tail or edge cases for autonomous driving, where each iteration of a cluster improves the classification of a rare fringe or edge case.

This may be particularly useful for out of distribution cases. For example, the detector 108 may be configured to detect cars and trees but may not yet be configured to detect cats. While the detector may have some information or distribution of objects that it can detect, the system is configured to differentiate between objects within the distribution and objects that are outside of the distribution. Thus, the system may begin to create a new cluster for out of distribution objects. The system may also correct the detector, based on examining a portion of the representative database, if the detector misclassifies a sensed information unit (e.g., the detector identifies a sensed information unit as pedestrian, but it is a utility pole). In this example, the utility pole may not be in a distribution available to the detector. The system may therefore create a new cluster for poles, or, more specifically, the particular type of pole. The system may distance the cluster for utility poles from the cluster for pedestrians to further improve differentiation between these two objects. Again, the distance between clusters may be determined by the similarities and/or dissimilarities between the vectors contained in the cluster, as identified by one or more vector descriptors.

Embodiments of the disclosure are configured to improve loss function for separation of out of distribution detected objects. The loss function may define an optimization problem, and the neural network may be configured to be trained according to the optimization problem. The loss function may determine what the neural network should detect and how the detection should occur.

Other improvements over current systems and methods include the ability to include multi-representative narrow concepts (e.g., scenarios or set of representing vectors) per class. A multi-representative narrow concept may be a plurality of narrow concepts that can each be used to describe or define a cluster for narrow object detection or perception. For example, a pedestrian cluster may include the narrow concepts of walking versus standing. The embeddings within the cluster may comprise information that enables the system to identify correlations and differentiations between the narrow concepts. Other examples of concepts may include different vehicle types and sizes (semi-truck vs small car), road objects, traffic zones (e.g., a school zone). Other examples may include weather or traffic conditions.

Other improvements over current systems and methods include the ability to provide dynamic concept manipulation. That is, a cluster may be dynamically modified without training or retraining the underlying neural network. The cluster modification may occur in real time (i.e., without having to wait until the system is offline).

Other improvements over current systems and methods include the ability to add classifications for object detection classes. To this end, residual training may be provided. For example, a group of objects may include a set of known classes or objects and one or more out of distribution classes. The neural network may falsely detect and/or classify an object (i.e., because the detector does not contain classifiers for the detected out of distribution object).

The residual training module may be configured to differentiate between known and out of distribution classes. The system may then create a set of objects and insert them into the set of known clusters. From this set, there may be out of distribution residue (objects that cannot be joined with the set). One or more of the out of distribution residual elements (e.g., identified common residual elements) may clustered and may then be inserted into a known cluster depending, for instance on the similarities between the out of distribution residual element and an available cluster that contains the most closely matched elements. Over time, due to the iterative nature of the process, particularly as it relates to low frequency events, as the clusters become more accurate, the out of distribution residue is reduced. The active learning module may then verify the mapping between the detected object and the cluster before further processing of the detected object. The system may also be configured to identify unclustered objects and reclassify them as belonging to a known cluster. The reclassified object clusters may then be fed back into the transformation module 102.

Following any of the above-described processing steps performed by the transformation module 102, the transformed output may be sent to an active learning module 104 for further processing. In some instances, the output from the transformation module 102 is one or more discriminating feature vectors. The output from the transformation module 102 can be fed as input to the active learning module 104 for generating signatures, and potential identification and removal of false alarms (e.g., false positives (FPs) or false negatives (FNs)).

Alternatively, the system may be configured to identify false alarms directly, i.e., edge case scenarios, including, for example, false positives/false negatives. Such false alarm identification may be useful in scenarios where the system does not include an active learning module and thus, does not generate signatures as described in the referenced disclosure of the active learning module. In other embodiments, the transformation module 102 is a stand-alone module configured to be provided an autonomous deliverable and would also therefore lack the signature generation functionality of the active learning module but would nonetheless provide false alarm identification and edge case classification as described herein.

The output of the active learning module 104 may then be sent to a clustering module 106. The clustering module 108 may be an automated process for clustering received information into one or more separate classifications. For instance, the clustering module 108 may cluster false positives into one or more classes, and may cluster subclasses of objects, as more information is input into the clustering module 106. The clusters may then be loaded back into the transformation module 102 for further processing or iteration to further refine the input data and increase the robustness and reliability of both inputs into the transformation module 102 and across the entire process. For instance, in the case of the transformation module, the clusters fed back into the transformation module provide additional data points to improve the formation and mapping of the discriminating feature vectors. This constant improvement enables the transformation module to achieve increasingly accurate signature management and object/feature detection.

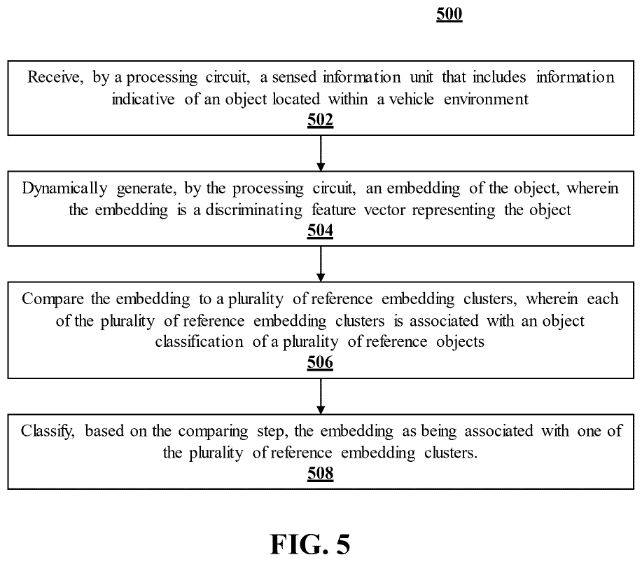

One general aspect includes a method 500 for object classification. FIG. 5 is a flow diagram of a method 500 for object detection and classification according to embodiments of the disclosure. The method 500 includes receiving 502, by a processing circuit, a sensed information unit that includes information indicative of an object located within a vehicle environment. Information may be received, for instance, from a detection unit, such as detection unit 102 of FIG. 1. The method 500 also includes dynamically generating 504, by the processing circuit, an embedding of the object, where the embedding is a discriminating feature vector representing the object. The method 500 also includes comparing 506 the embedding to a plurality of reference embedding clusters, where each of the plurality of reference embedding clusters is associated with an object classification of a plurality of reference objects. The method 500 also includes classifying 508, based on the comparing step, the embedding as being associated with one of the plurality of reference embedding clusters.

Implementations may include one or more of the following features. The method 500 may include limiting the dynamic range of the sensed information unit. The sensed information unit may include a cropped sensed information unit cropped from a sensed information unit received from a sensing unit of the vehicle. The supervised machine learning training may include applying a cost function that induces generation of similar reference embeddings to similar objects and dissimilar reference embeddings to dissimilar objects. The classifying step initiates further processing of the sensed information unit. The plurality of reference embedding clusters represents a larger group of reference embeddings, where the larger group of reference embeddings is generated during a supervised machine learning training may include feeding cropped images to a bounding shape generating neural network. The method 500 may include dynamically updating the plurality of reference embedding clusters. The plurality of reference embedding clusters is generated by clustering one or more subgroups of reference embeddings of a larger group of reference embeddings into a plurality of clusters.

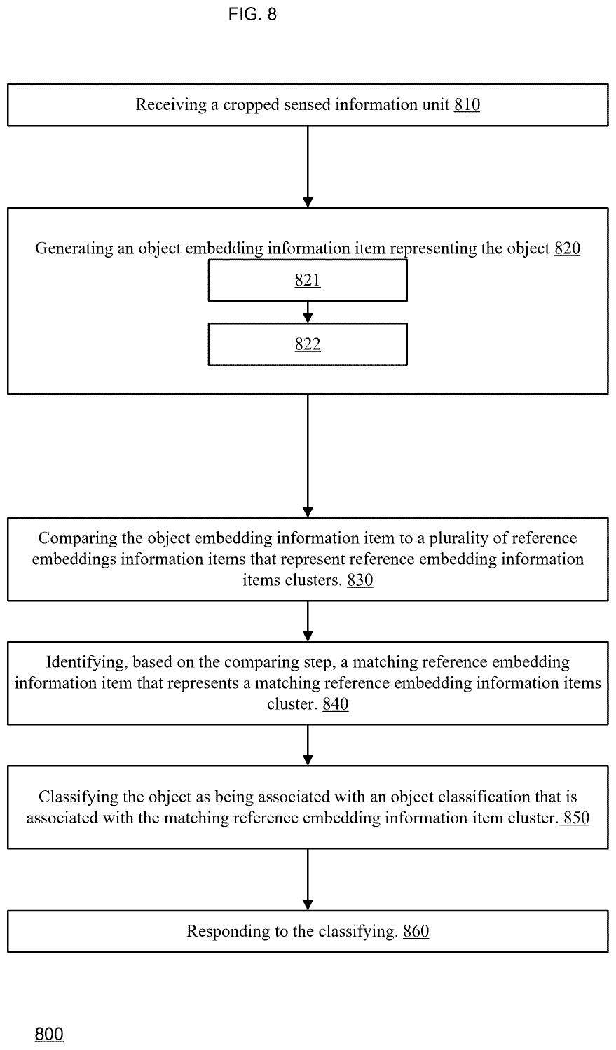

FIG. 8 illustrates an example of method 800.

According to an embodiment method 800 is for object classification.

According to an embodiment, method 800 includes step 810 of receiving, by a processing circuit, a cropped sensed information unit that includes information indicative of an object located within an environment of a vehicle.

According to an embodiment, step 810 is followed by step 820 of generating, by the processing circuit, an object embedding information item representing the object.

An embedding information item may be an embedding or a representation (for example signature) of the embedding.

According to an embodiment, step 820 is followed by step 830 of comparing the object embedding information item to a plurality of reference embeddings information items that represent reference embedding information items clusters.

According to an embodiment, step 830 is followed by step 840 of identifying, based on the comparing step, a matching reference embedding information item that represents a matching reference embedding information items cluster.

According to an embodiment, step 840 is followed by step 850 of classifying the object as being associated with an object classification that is associated with the matching reference embedding information item cluster.

According to an embodiment, step 850 is followed by step 860 of responding to the classifying.

According to an embodiment, step 860 may include at least one of:
a. Triggering a determination of a driving related operation to be executed by the vehicle. The driving related operation may be a fully autonomous operation such as maintaining a current progress of a vehicle, changing a progress of the vehicle, whereas a progress refers to at least one of direction of propagation, speed of propagation and acceleration of the vehicle. Alternatively—the driving related operation is an ADAS operation such as suggesting a driving scheme operation of performing a more limited driving related operation (limited in the sense of its duration).
b. Executing a driving related operation.
c. Determining a navigation path of the vehicle.
d. Populating a database with an outcome of the vehicle.
e. Sending an one or more artificial intelligence agents information regarding the classification.
f. Activating one or more artificial intelligence agents based on the classification.
g. Further processing an initial (pre-cropping) sensed information unit. The cropped information unit was generated by cropping an initial (pre-cropping) information sensing unit.

According to an embodiment, the object embedding information item is an object embedding signature. The reference embeddings information items are reference embeddings signatures. The reference embedding information items clusters are reference embedding signatures clusters.

According to an embodiment, a signature of an embedding is of a higher dimension (also referred to a higher dimensionality or having more dimensions) than the embedding. The increase of the dimensionality may increase the robustness of the detection as higher dimensionality increases the distance between adjacent signatures—in comparison to the distance between corresponding adjacent embeddings. The higher dimension may include having at least 2, 5, 10, 20, 50, 80, 100 dimensions and even more.

A non-limiting example of generating a signature is illustrated in US patent application 2022/0041184 which is incorporated herein by reference.

According to an embodiment, step 820 includes step 821 of generating an object embedding and step 822 of generating the signature of the object embedding, wherein the object embedding has less dimensions than the object embedding signature.

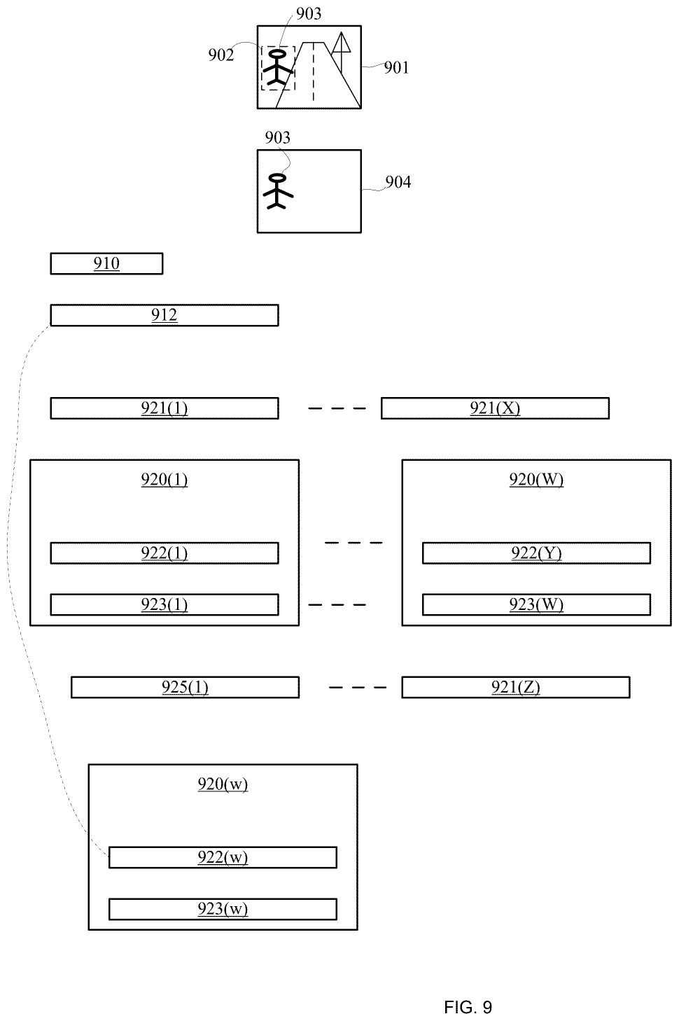

FIG. 9 illustrates an example of an initial sensed information unit such as an image 901 including a bounding box 902 that is indicative of a location of object 903, a cropped image 904 that mostly includes the pixels of the object 903, an object embedding 910 of the cropped image, a signature 912 of the object embedding, reference embedding signatures clusters 920(1)-920(W) that are represented by reference embedding signatures 921(1)-921(X) (that may or may not be include din the reference embedding signature clusters), wherein there may be more than one reference embedding signature per reference embedding signature cluster, other reference embedding signatures 922(1)-922(Y) included in the reference embedding signatures clusters (and differ from the reference embedding signatures 921(1)-921(X)), outliers 925(1)-925(Z) located outside the clusters, reference embedding signatures clusters metadata (923(1)-923(W)) that provide information such as object classification about the clusters, and a matching reference embedding signatures cluster 920(w) that is represented by reference embedding signature 921(w) and is associated with metadata 923(w) indicative of an object classification.

According to an embodiment, the object embedding information item is an object embedding, the reference embeddings information items are reference embeddings, and the reference embedding information items clusters are reference embedding clusters. An example of comparing embeddings to clusters is found in FIG. 3.

According to an embodiment the cropped sensed information unit consists essentially of the information indicative of the object. The cropping increases the accuracy of the object embedding as irrelevant information is mostly removed from the cropped sensed information unit.

According to an embodiment, the cropped sensed information unit was generated based on an initial sensed information unit and a bounding box indicative of the object within the initial sensed information unit.

According to an embodiment, the cropped sensed information was generated based on an initial sensed information unit and a plurality of keypoints within the initial sensed information unit that are associated with the object. Keypoints may be found in any known manner. According to an embodiment, a keypoint is found in the manner illustrated in U.S. Pat. No. 11,037,015 which is incorporated herein by reference.

According to an embodiment, cropped sensed information was generated based on an initial sensed information unit and an initial sensed information unit region that includes a plurality of keypoints within the initial sensed information unit that are associated with the object.

Assuming, that the transformation module (especially an embedding generator within the transformation module) is configured to process content of a given shape—for example it is configured to process a cropped sensed information unit that includes relevant information within a rectangular region of a sensed information unit—then the method includes defining a rectangular region to include the plurality of keypoints (the rectangular region may be defined to be as small as possible—or to include up a limited amount of information outside a smallest region that includes the keypoints)—and to process the content of the rectangular region. The processing may include aligning the rectangular region (which may be oriented to the horizon) before providing the rectangular box to the embedding generator.

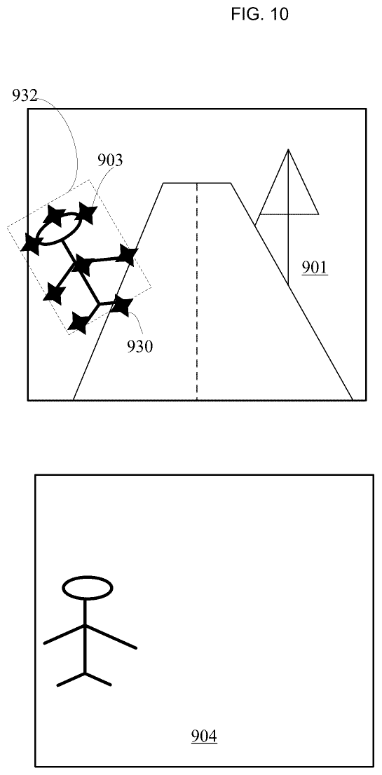

FIG. 10 illustrates a sensed information unit such as image 950, including object 903, including keypoints 930 of the object, a bounding box 932 that surrounds the keypoints 930, and a cropped image 904. The bounding box 932 is oriented and the cropped image include an aligned bounding box 933.

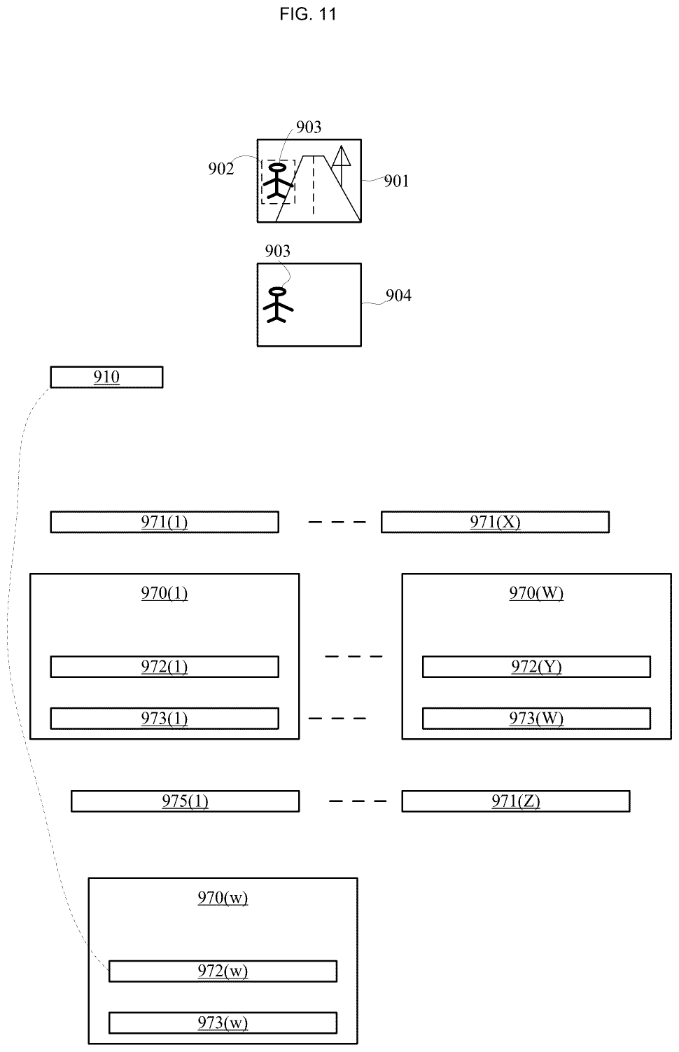

FIG. 11 illustrates an example of an initial sensed information unit such as an image 901 including a bounding box 902 that is indicative of a location of object 903, a cropped image 904 that mostly includes the pixels of the object 903, an object embedding 910 of the cropped image, reference embedding clusters 970(1)-970(W) that are represented by reference embedding 971(1)-971(X), wherein there may be more than one reference embedding per reference embedding cluster, other reference embedding 972(1)-972(Y) included in the reference embedding clusters (and differ from the reference embedding 971(1)-971(X)), outliers 975(1)-975(Z) located outside the clusters, reference embedding clusters metadata (973(1)-973(W)) that provide information such as object classification about the clusters, and a matching reference embedding cluster 970(w) that is represented by reference embedding 971(w).

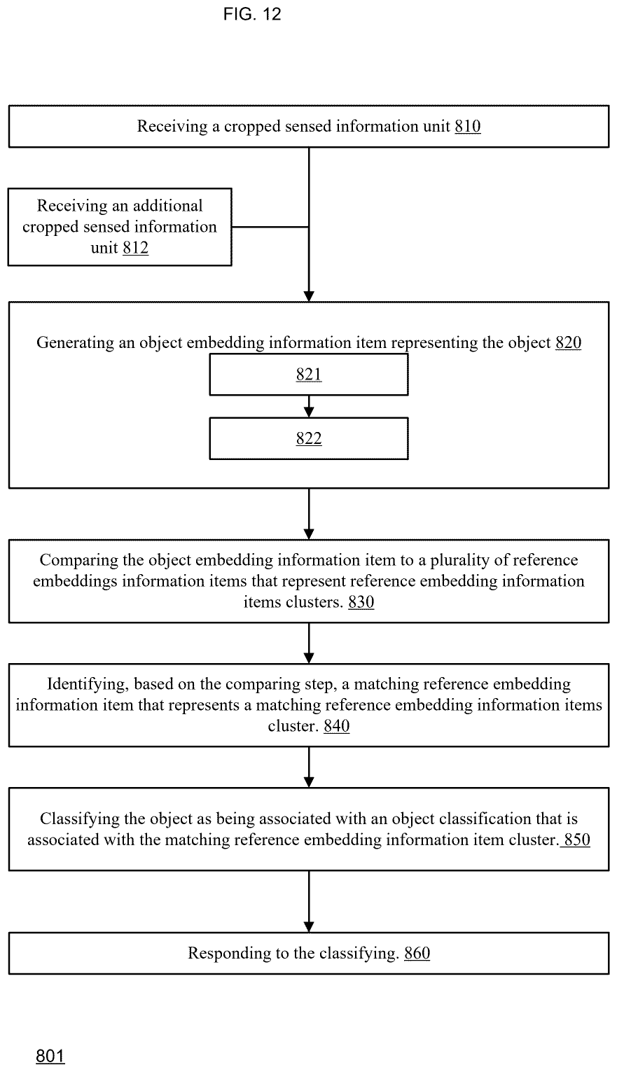

FIG. 12 illustrates an example of method 801.

According to an embodiment method 80′ is for object classification.

According to an embodiment, method 80′ includes step 810 of receiving, by a processing circuit, a cropped sensed information unit that includes information indicative of an object located within an environment of a vehicle.

According to an embodiment, method 810 also includes step 812 of receiving, by the processing circuit, an additional cropped sensed information unit that includes additional information indicative of the object located within the vehicle environment. While the cropped sensed information unit received in step 810 was sensed by a sensor of a first type, the additional cropped sensed information unit was sensed by a sensor of second type differs from the first type. The types of sensors may differ from each other by radiation frequency (for example radar versus visible light), resolution, point of view (for example aerial point of view or ground level point of view), active sensor versus passive sensor, and the like. Examples of sensors of different types include a visual light camera, an audio sensor, a sensor that may sense infrared, radar imagery, ultrasound, electro-optics, radiography, LIDAR (light detection and ranging), and the like.

According to an embodiment, step 810 and step 812 are followed by step 820 of generating, by the processing circuit, an object embedding information item representing the object.

According to an embodiment, step 820 is followed by step 830 of comparing the object embedding information item to a plurality of reference embeddings information items that represent reference embedding information items clusters.

According to an embodiment, step 830 is followed by step 840 of identifying, based on the comparing step, a matching reference embedding information item that represents a matching reference embedding information items cluster.

According to an embodiment, step 840 is followed by step 850 of classifying the object as being associated with an object classification that is associated with the matching reference embedding information item cluster.

According to an embodiment, step 850 is followed by step 860 of responding to the classifying.

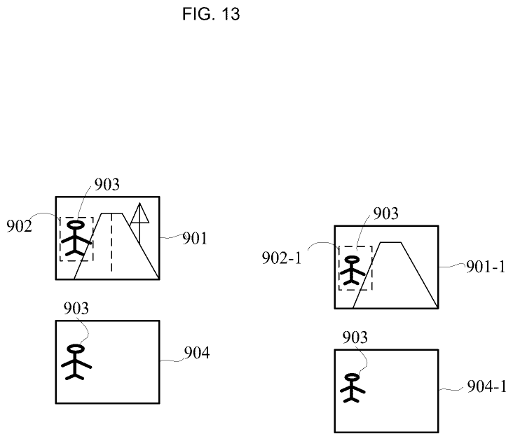

FIG. 13 illustrates an example of an initial sensed information unit such as an image 901 including a bounding box 902 that is indicative of a location of object 903, a cropped image 904 that mostly includes the pixels of the object 903, an additional initial sensed information unit such as an additional image 901-1 including a bounding box 902-1 that is indicative of a location of object 903, an additional cropped image 904-4 that mostly includes the pixels of the object 903. The additional image is acquired by a sensor of a different type that the sensor that sensed image 901.

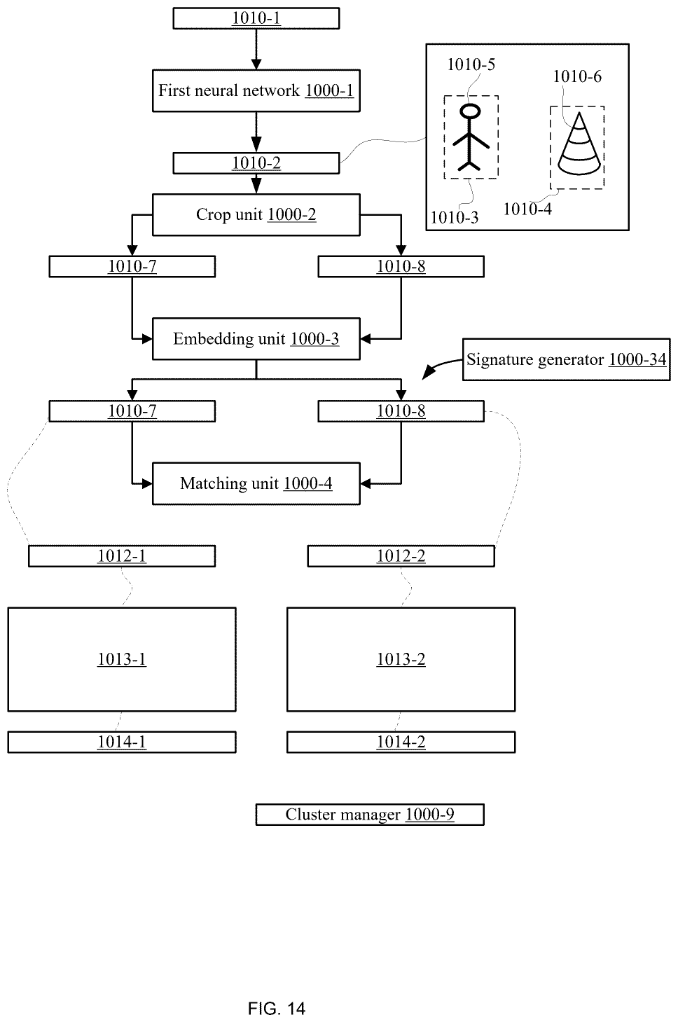

FIG. 14 illustrates an example of a system 101 that includes a first neural network 1000-1 configured to receive a sensed information unit such as image 1010-1 and perform an object detection to provide an first output image 1010-2 with first bounding box 1010-3 and second bounding box 1010-4 corresponding to first object 1010-5 and second object 1010-6, the first output image 1010-2 is sent to an crop unit 1000-2 configured to generate first cropped image 1010-7 and second cropped 1010-8-associated with the first and second objects, respectively. The first and second cropped images are fed to embedding unit 1000-3 that generates a first object embedding 1010-11 and a second object embedding 1010-12.

A matching unit 1000-4 identifies, for each one of the first object embedding and a second object embedding a matching reference embedding—first matching reference embedding 1012-1 and second matching reference embedding 1012-2. It there is no match for any one of the object embeddings than that object embedding is regarded to be an outlier.

Assuming a first object related match—the first matching reference embedding 1012-1 represents a first reference embedding cluster 1013-1 associated with a first object classification 1014-1—and the first object is classified as belonging to the first object classification 1014-1.

Assuming a second object related match—the second matching reference embedding 1012-2 represents a second reference embedding cluster 1013-2 associated with a second object classification 1014-2—and the second object is classified as belonging to the second object classification 1014-2.

According to an embodiment, the matching and the clustering are not executed in the embedding domain but at the embedding signature domain. Accordingly-there is an embedding signature generator 1000-34 between the embedding unit 1000-3 and the matching unit 1004. In this case the matching unit 1000-4 identifies, for each object embedding signature a matching reference embedding signature that represents a reference embedding signature cluster associated with an object classification 1014-1.

It should be noted that the clusters are managed (re-evaluated, reduced, re-defined) by a cluster manager 1000-9.

According to an embodiment, the object detection applied by the first neural network 1000-1 includes estimating a presence of an object within the sensed information unit. In addition to the bounding box, the first neural network also outputs its estimation of the object associated with the bounding box. This estimate is referred to as an initial object estimate. For example-first bounding box 1010-3 is associated with first object 1010-5 that is initially estimated to be a pedestrian.

According to an embodiment, system 101 generates first cropped image 1010-7 that includes the first object, generates a first object embedding 1010-11, finds a first matching reference embedding 1012-1 that represents a first reference embedding cluster 1013-1 associated with a first object classification 1014-1-classifies the first object as belonging to the first object classification 1014-1.

According to an embodiment, when there is a mismatch between the first object classification 1014-1 and the initial estimate of the initial object estimate—system 101 determines that at least one of the initial object estimate or the first object embedding is faulty.

According to an embodiment, a mismatch occurs when the initial object estimate and the first object classification contradict each other—for example, the initial object estimate is of a pedestrian and the first object classification is of a vehicle.

According to an embodiment, a difference between the initial object estimate and the first object classification is not regarded as a mismatch. Such a difference may be attributed to the higher accuracy of the matching process—which may provide more details about the first object. For example—the initial object estimate may be coarser than the first object classification (may have coarser or broader classes than the finer classes used to determine the initial object estimate).

For example, the initial object estimate may provide an estimate of a type of an object (for example a vehicle) and the first object classification may determine a sub-type of the object (for example a minivan, a SUV, a station wagon, a vehicle manufactured by a certain manufacturer, a model of the vehicle).

According to an embodiment, when there is a mismatch the system estimates that the initial object estimate is faulty—as the matching process is regarded to be more reliable than the initial object estimate.

According to an embodiment, the system is configured to respond to the mismatch.

According to an embodiment, the response includes at least one of: providing an indication of a first neural network error, requesting or suggesting to train the first neural network, requesting or suggesting or instructing to evaluate the embedding process, requesting or suggesting or instructing to evaluate the matching process, requesting or suggesting or instructing to evaluate the cropping process, requesting or suggesting or instructing to use a FP removal module (such as FP removal module 110 of FIG. 1) to perform a FP removal operation, requesting or suggesting or instructing to perform a cluster management operation such as re-clustering or deleting a cluster or adding a cluster or changing one or more clustering parameter such as a distance between cluster members, a distance between members of different clusters, and the like.

### Lane Detection

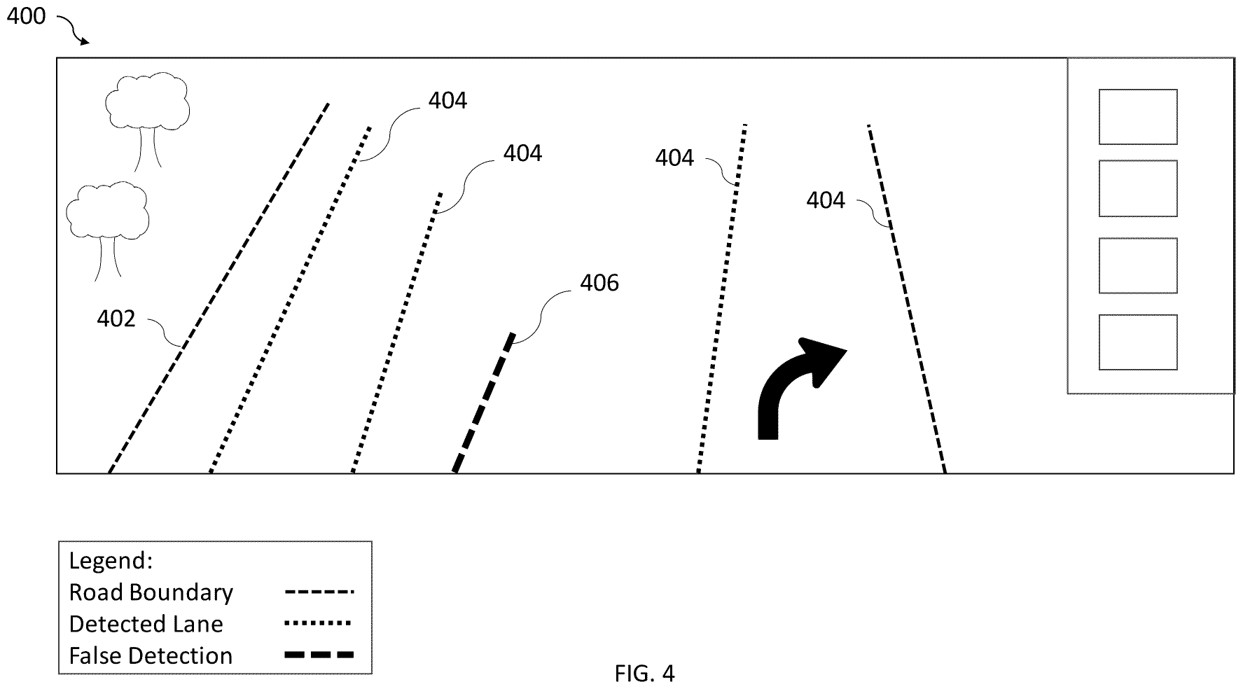

Embodiments of the object detection and classification systems and methods may be applied to travel lane feature classification. To this end, one general aspect includes a system for travel lane feature classification. One or more of the components of system 100 of FIG. 1 may be utilized to execute the steps of the travel lane feature classification. In particular, the transformation module 102 is configured to provide travel lane feature classification, where the output of the transformation module 102 as it relates to travel lane feature classification may be sent to other modules of the system and/or the processed output may be fed back into the transformation module for training. FIG. 4 illustrates an example 400 of identifying and processing sensed travel lane features according to embodiments of the disclosure The system may be configured to obtain, via a processing circuit, information indicative of a travel lane including one or more travel lane features located within a vehicle environment. The obtaining step may include obtaining, by an imaging sensor, a field of view image of a viewable area including the environment of the vehicle. The travel lane features may include any of road boundaries 402, travel lane markers 404 and/or false detections 406 (e.g., road markings such as a tar line or other misdetection not indicative of a travel lane or road boundary).

The system 400 may be configured as 2 stage neural network system. The system 400 may be configured to obtain or generate a plurality of keypoints from the information. At a first stage, i.e., via the detector 108, the system may obtain a list of keypoints, from, for example, a third party service. The clusters may then include the representative vectors that represent possible lanes.

The system may be configured to organize the plurality of keypoints into one or more subgroups of keypoints, where each of the one or more subgroups of keypoints is indicative of one or more categories of travel lane features. The system may cluster the keypoints into different classifications of features (e.g., road boundaries 402, travel lane markers 404 and/or false detections 406). The classifications may be accomplished by comparing the keypoints with the ground truth. The organizing step may include clustering each of the one or more subgroups of keypoints according to one or more pre-determined aspect ratios (e.g., long lines, short lines, intermediate length lines). The organizing step may include clustering the one or more subgroups of keypoints based on the predetermined aspect ratios. The organizing step may include training a classifier (e.g., transformation module 102) to classify each of the one or more subgroups of keypoints based on the aspect ratios. The classifications may include either “travel lane” or “false detection”.

The system may be configured to cluster each of the one or more subgroups of keypoints according to one or more pre-determined aspect ratios. The cropping the clustered one or more subgroups of keypoints may be accomplished by determining minimum shape dimensions of a shape bounding the clustered one or more subgroups of keypoints. A lateral margin and a vertical margin may be added to the minimum shape dimensions. The lateral and vertical margins may consist of a predetermined number of pixels, in an example involving a captured image. Otherwise, the lateral and vertical margins may be determined based on the relative distance between two or more markings visible in the image. The system may then be configured to rotate the cropped clustered one or more subgroups of keypoints to an upright position. The system may be configured to resize the upright cropped clustered one or more subgroups of keypoints to a fixed size before training. In this manner, consistent results can be obtained regardless of the size of the input image or crop.

The system may be configured to classify, based on the organizing step, the one or more organized subgroups of keypoints as indicative of a travel lane marker or a false detection. The system may be configured to classify, based on the organizing step, at least a second subgroup of keypoints as indicative of a road boundary. The system may be configured to classify, based on the organizing step, at least a third subgroup of keypoints as indicative of an incidental marking.

During an inference phase, the above steps may be repeated. In this manner, the accuracy of the travel lane classification and detection may be improved with each iteration.

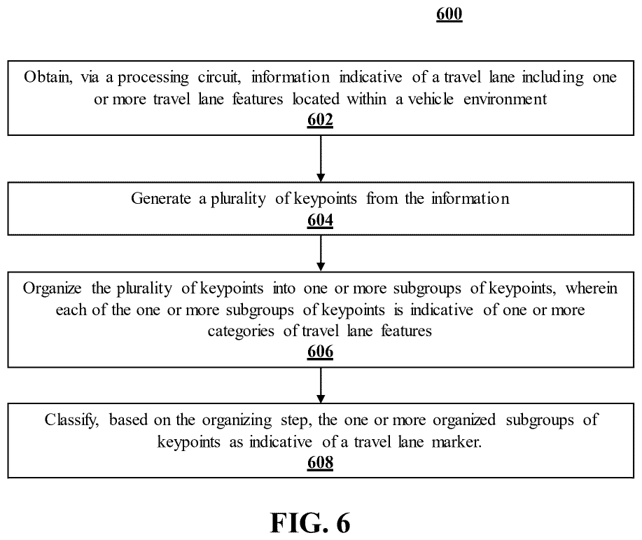

One general aspect includes a method 600 for travel lane feature classification. FIG. 6 is a flow diagram of a method 600 for travel lane feature detection and classification according to embodiments of the disclosure. The method 600 includes obtaining 602, via a processing circuit, information indicative of a travel lane including one or more travel lane features located within a vehicle environment. The method also includes generating 604 a plurality of keypoints from the information.

The method 600 also includes organizing 606 the plurality of keypoints into one or more subgroups of keypoints, where each of the one or more subgroups of keypoints is indicative of one or more categories of travel lane features. The method 600 also includes classifying 608, based on the organizing step, the one or more organized subgroups of keypoints as indicative of a travel lane marker. Other embodiments of this aspect include corresponding computer systems, apparatus, and computer programs recorded on one or more computer storage devices, each configured to perform the actions of the methods.

Implementations may include one or more of the following features. The obtaining step may include obtaining, by an imaging sensor, a field of view image of a viewable area including the environment of the vehicle. The organizing step may include clustering each of the one or more subgroups of keypoints according to one or more pre-determined aspect ratios. The method may include cropping the clustered one or more subgroups of keypoints by determining minimum shape dimensions of a shape bounding the clustered one or more subgroups of keypoints, and adding a lateral margin and vertical margin to the minimum shape dimensions.

According to an embodiment, the information is a sensed information unit. Each subgroup of keypoints is located within a region of the sensed information unit. A cropping of a subgroup of keypoints includes generating a cropped sensed information unit that per region (in which the subgroup of keypoints is located).

The method 600 may include rotating the cropped clustered one or more subgroups of keypoints to an upright position. The method 600 may include resizing the upright cropped clustered one or more subgroups of keypoints to a fixed size.

The organizing step may include clustering the one or more subgroups of keypoints based on aspect ratios. The organizing step may include training a classifier to classify each of the one or more subgroups of keypoints based on the aspect ratios. The method may include classifying, based on the organizing step, at least a second subgroup of keypoints as indicative of a road boundary. The method may include classifying, based on the organizing step, at least a third subgroup of keypoints as indicative of an incidental marking.

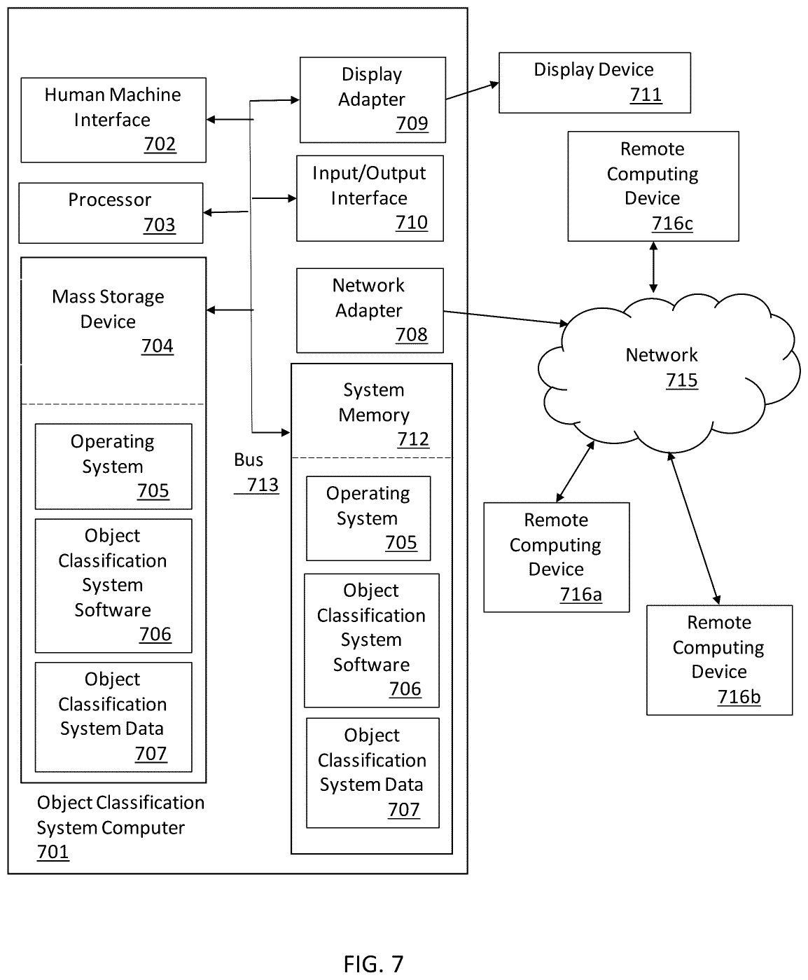

FIG. 7 is a block diagram illustrating an exemplary operating environment for performing at least a portion of disclosed methods according to an embodiment of the present invention. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

Further, one skilled in the art will appreciate that the systems and methods disclosed herein can utilize a specialized computing device in the form of an object classification system computer 701 (which may be included in, for example object classification system 100). The methods discussed above can be performed by the computer 701. For example, the computer 701 can perform the duties and responsibilities discussed above.

The components of the object classification system computer 701 can comprise, but are not limited to, one or more processors or processing units 703, a system memory 712, and a system bus 713 that couples various system components including the processor 703 to the system memory 712. In the case of multiple processing units 703, the system can utilize parallel computing.

The system bus 713 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 713, and all buses specified in this description can also be implemented over a wired or wireless network connection and each of the subsystems, including the processor 703, a mass storage device 704, an operating system 705, object classification system software 706, object classification system data 707, a network adapter 708, system memory 712, an Input/Output Interface 710, a display adapter 709, a display device 711, and a human machine interface 702, can be contained within one or more remote computing devices 714 a,b,c at physically separate locations, connected through buses of this form, in effect implementing a fully distributed system.

The object classification system computer 701 typically comprises a variety of computer readable media. Exemplary readable media can be any available media that is accessible by the object classification system computer 701 and comprises, for example and not meant to be limiting, both volatile and non-volatile media, removable and non-removable media. The system memory 712 comprises computer readable media in the form of volatile memory, such as random access memory (RAM), and/or non-volatile memory, such as read only memory (ROM). The system memory 712 typically contains data such as object classification system data 707 and/or program modules such as operating system 705 and object classification system software 706 (i.e., modules and the like that perform the methods discussed above) that are immediately accessible to and/or are presently operated on by the processing unit 703.

In another aspect, the object classification system computer 701 can also comprise other removable/non-removable, volatile/non-volatile computer storage media. By way of example, FIG. 7 illustrates a mass storage device 704, which can provide non-volatile storage of computer code, computer readable instructions, data structures, program modules, and other data for the object classification system computer 701. For example and not meant to be limiting, a mass storage device 704 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 704, including by way of example, an operating system 705 and object classification system software 706. Each of the operating system 705 and object classification system software 706 (or some combination thereof) can comprise elements of the programming and the object classification system software 706. object classification system data 707 can also be stored on the mass storage device 704. object classification system data 707 can be stored in any of one or more databases known in the art. Examples of such databases include DB2®, Microsoft® Access, Microsoft® SQL Server, Oracle®, mySQL, PostgreSQL, and the like. The databases can be centralized or distributed across multiple systems. In other aspects, the object classification system data 707 can be stored on the mass storage device 705 of other servers or devices (e.g., remote computing device 714 a,b,c,) in communication with the object classification system computer 701.

In another aspect, the user can enter commands and information into the object classification system computer 701 via an input device (not shown). Examples of such input devices comprise, but are not limited to, a keyboard, pointing device (e.g., a “mouse”), a microphone, a joystick, a scanner, tactile input devices such as gloves, and other body coverings, and the like. These and other input devices can be connected to the processing unit 703 via a human machine interface 702 that is coupled to the system bus 713, but can be connected by other interface and bus structures, such as a parallel port, game port, an IEEE 1394 Port (also known as a Firewire port), a serial port, or a universal serial bus (USB).

In yet another aspect, a display device 711 can also be connected to the system bus 713 via an interface, such as a display adapter 709. It is contemplated that the object classification system computer 701 can have more than one display adapter 709 and more than one display device 711. For example, a display device can be a monitor, an LCD (Liquid Crystal Display), or a projector. In addition to the display device 711, other output peripheral devices can comprise components such as speakers (not shown) and a printer (not shown) which can be connected to the computer 701 via Input/Output Interface 710. Any step and/or result of the methods can be output in any form to an output device. Such output can be any form of visual representation, including, but not limited to, textual, graphical, animation, audio, tactile, and the like.

The object classification system computer 701 can operate in a networked environment using logical connections to one or more remote computing devices 714 a, b, c. By way of example, a remote computing device can be a personal computer, a laptop computer, portable computer, a server, a router, a network computer, a peer device or other common network node, and so on. Logical connections between the object classification system computer 701 and a remote computing device 714 a, b, c can be made via a local area network (LAN) and a general wide area network (WAN). Such network connections can be through a network adapter 708. A network adapter 708 can be implemented in both wired and wireless environments. Such networking environments are conventional and commonplace in offices, enterprise-wide computer networks, intranets, and a network 715 such as the internet 715.

For purposes of illustration, application programs and other executable program components such as the operating system 705 are illustrated herein as discrete blocks, although it is recognized that such programs and components reside at various times in different storage components of the object classification system computer 701, and are executed by the data processor(s) of the computer. An implementation of object classification system software 706 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

According to an embodiment, object classification system computer 701 is configured to execute any method illustrated in the application.

According to an embodiment the object classification system computer 701 is in communication with one or more sensors of one or more types that are associated with the vehicle.

According to an embodiment the object classification system computer 701 is in communication with other vehicle computes such as control computers that are configured to control one or more vehicle units such as an engine controlling computer, a powertrain controlling computer, and/or with an autonomous driving unit configured to control autonomous driving, an ADAS unit configured to control ADAS operations, a path unit configured to navigate the vehicle, and the like. Each unit includes a processing circuit and/or stores in a non-transitory computer readable medium software and/or firmware and/or code and/or instructions for fulfilling the role of the unit.

System of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for object classification. The method also includes receiving, by a processing circuit, a sensed information unit that includes information indicative of an object located within a vehicle environment. The method also includes dynamically generating, by the processing circuit, an embedding of the object, where the embedding is a discriminating feature vector representing the object. The method also includes comparing the embedding to a plurality of reference embedding clusters, where each of the plurality of reference embedding clusters is associated with an object classification of a plurality of reference objects. The method also includes classifying, based on the comparing step, the embedding as being associated with one of the plurality of reference embedding clusters. Other embodiments of this aspect include corresponding computer systems, apparatus, and computer programs recorded on one or more computer storage devices, each configured to perform the actions of the methods.

Implementations of the method for object classification may include one or more of the following features. The method may include limiting the dynamic range of the sensed information unit. The sensed information unit may include a cropped sensed information unit cropped from a sensed information unit received from a sensing unit of the vehicle. The supervised machine learning training may include applying a cost function that induces generation of similar reference embeddings to similar objects and dissimilar reference embeddings to dissimilar objects. The classifying step initiates further processing of the sensed information unit. The plurality of reference embedding clusters represents a larger group of reference embeddings, where the larger group of reference embeddings is generated during a supervised machine learning training may include feeding cropped images to a bounding shape generating neural network. The method may include dynamically updating the plurality of reference embedding clusters. The plurality of reference embedding clusters is generated by clustering one or more subgroups of reference embeddings of a larger group of reference embeddings into a plurality of clusters.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for travel lane feature classification. The method also includes obtaining, via a processing circuit, information indicative of a travel lane including one or more travel lane features located within a vehicle environment. The method also includes generating a plurality of keypoints from the information. The method also includes organizing the plurality of keypoints into one or more subgroups of keypoints, where each of the one or more subgroups of keypoints is indicative of one or more categories of travel lane features. The method also includes classifying, based on the organizing step, the one or more organized subgroups of keypoints as indicative of a travel lane marker. Other embodiments of this aspect include corresponding computer systems, apparatus, and computer programs recorded on one or more computer storage devices, each configured to perform the actions of the methods.

Implementations of the method for travel lane feature classification may include one or more of the following features. The obtaining step may include obtaining, by an imaging sensor, a field of view image of a viewable area including the environment of the vehicle. The organizing step may include clustering each of the one or more subgroups of keypoints according to one or more pre-determined aspect ratios. The method may include cropping the clustered one or more subgroups of keypoints by: determining minimum shape dimensions of a shape bounding the clustered one or more subgroups of keypoints; and adding a lateral margin and vertical margin to the minimum shape dimensions. The method may include rotating the cropped clustered one or more subgroups of keypoints to an upright position. The method may include resizing the upright cropped clustered one or more subgroups of keypoints to a fixed size. The organizing step may include clustering the one or more subgroups of keypoints based on aspect ratios. The organizing step may include training a classifier to classify each of the one or more subgroups of keypoints based on the aspect ratios. The method may include classifying, based on the organizing step, at least a second subgroup of keypoints as indicative of a road boundary. The method may include classifying, based on the organizing step, at least a third subgroup of keypoints as indicative of an incidental marking. Implementations of the described techniques may include hardware, a method or process, or computer software on a computer-accessible medium.

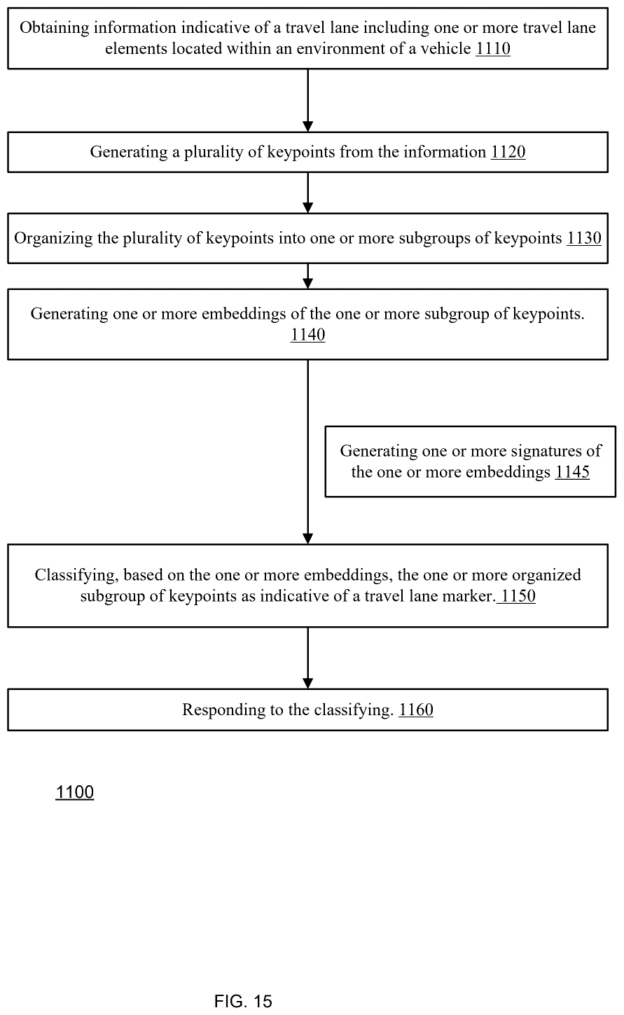

FIG. 15 illustrates an example of a method 1100 for travel lane element classification.

According to an embodiment, method 1100 includes step 1110 of obtaining, via a processing circuit, information indicative of a travel lane including one or more travel lane elements located within an environment of a vehicle.

According to an embodiment, step 1110 is followed by step 1120 of generating a plurality of keypoints from the information.

According to an embodiment, step 1120 is followed by step 1130 of organizing the plurality of keypoints into one or more subgroups of keypoints, wherein each of the one or more subgroup of keypoints is indicative of one or more categories of travel lane elements.

According to an embodiment, step 1130 is followed by step 1140 of generating one or more embeddings of the one or more subgroup of keypoints.

According to an embodiment, step 1140 is followed by step 1150 of classifying, based on the one or more embeddings, the one or more organized subgroup of keypoints as indicative of a travel lane marker.

According to an embodiment, step 1150 is followed by step 1160 of responding to the classifying.

According to an embodiment, step 1160 may include at least one of:
a. Triggering a determination of a driving related operation to be executed by the vehicle. The driving related operation may be a fully autonomous operation such as maintaining a current progress of a vehicle, changing a progress of the vehicle, whereas a progress refers to at least one of direction of propagation, speed of propagation and acceleration of the vehicle. Alternatively—the driving related operation is an ADAS operation such as suggesting a driving scheme operation of performing a more limited driving related operation (limited in the sense of its duration).
b. Executing a driving related operation.
c. Determining a navigation path of the vehicle.
d. Populating a database with an outcome of the vehicle.
e. Sending an one or more artificial intelligence agents information regarding the classification.
f. Activating one or more artificial intelligence agents based on the classification.
g. Further processing an initial (pre-cropping) sensed information unit. The cropped information unit was generated by cropping an initial (pre-cropping) information sensing unit.

According to an embodiment, method 1100 includes step 1145 of generating one or more signatures of the one or more embeddings, the one or more signatures are of higher dimensionality that the one or more embeddings, wherein the classifying is based on the one or more signatures.

Step 1150 of classifying the one or more organized subgroup of keypoints as indicative of a travel lane marker will be based on the signatures of the one or more embeddings.

According to an embodiment, the information indicative of the travel lane is a sensed information unit, and step 1140 may include or may be preceded by generating one or more cropped sensed information units, one cropped information unit per subgroup of keypoints. The one or more embeddings are generated based on the one or more cropped sensed information unit.

Any combination of any step of any method illustrated in the application is provided.

According to an embodiment there is provided a method that includes receiving, by a processing circuit, a sensed information unit that includes information indicative of an object located within a vehicle environment; dynamically generating, by the processing circuit, an embedding of the object, wherein the embedding is a discriminating feature vector representing the object; comparing the embedding to a plurality of reference embedding clusters, wherein each of the plurality of reference embedding clusters is associated with an object classification of a plurality of reference objects; and classifying, based on the comparing step, the embedding as being associated with one of the plurality of reference embedding clusters.

According to an embodiment the method further includes limiting the dynamic range of the sensed information unit.

According to an embodiment, the sensed information unit is a cropped sensed information unit.

According to an embodiment, the classifying step initiates further processing of the sensed information unit.

According to an embodiment, the plurality of reference embedding clusters represents a larger group of reference embeddings, wherein the larger group of reference embeddings is generated during a supervised machine learning training comprising feeding cropped images to a bounding shape generating neural network.

According to an embodiment, the supervised machine learning training comprises applying a cost function that induces generation of similar reference embeddings to similar objects and dissimilar reference embeddings to dissimilar objects.

According to an embodiment, the method includes dynamically updating the plurality of reference embedding clusters.

According to an embodiment, the plurality of reference embedding clusters is generated by clustering one or more subgroups of reference embeddings of a larger group of reference embeddings into a plurality of clusters.

According to an embodiment there is provided a non-transitory computer readable medium for object classification, the non-transitory computer readable medium stores instructions that once executed by an object classification system of the vehicle cause the object classification system to: receive a sensed information unit that includes information indicative of an object located within a vehicle environment; dynamically generate an embedding of the object, wherein the embedding is a discriminating feature vector representing the object; compare the embedding to a plurality of reference embedding clusters, wherein each of the plurality of reference embedding clusters is associated with an object classification of a plurality of reference objects; and classify, based on the comparing step, the embedding as being associated with one of the plurality of reference embedding clusters.

According to an embodiment, the object classification system is further configured to limit the dynamic range of the sensed information unit.

According to an embodiment, the sensed information unit is a cropped sensed information unit.

According to an embodiment, the classifying step initiates further processing of the sensed information unit.

According to an embodiment, the plurality of reference embedding clusters represents a larger group of reference embeddings, wherein the larger group of reference embeddings is generated during a supervised machine learning training comprising feeding cropped images to a bounding shape generating neural network.

According to an embodiment, the supervised machine learning training comprises applying a cost function that induces generation of similar reference embeddings to similar objects and dissimilar reference embeddings to dissimilar objects.

According to an embodiment, the object classification system is further configured to dynamically update the plurality of reference embedding clusters.

According to an embodiment, the plurality of reference embedding clusters is generated by clustering one or more subgroups of reference embeddings of a larger group of reference embeddings into a plurality of clusters.

According to an embodiment there is provided an object classification system of a vehicle, the object classification system comprising: one or more processing circuits that comprise at least a part of an integrated circuit, the one or more processing circuits are configured to: receive a sensed information unit that includes information indicative of an object located within a vehicle environment; dynamically generate an embedding of the object, wherein the embedding is a discriminating feature vector representing the object; compare the embedding to a plurality of reference embedding clusters, wherein each of the plurality of reference embedding clusters is associated with an object classification of a plurality of reference objects; and classify, based on the comparing step, the embedding as being associated with one of the plurality of reference embedding clusters.

According to an embodiment, the plurality of reference embedding clusters represents a larger group of reference embeddings, wherein the larger group of reference embeddings is generated during a supervised machine learning training comprising feeding cropped images to a bounding shape generating neural network.

According to an embodiment, the supervised machine learning training comprises applying a cost function that induces generation of similar reference embeddings to similar objects and dissimilar reference embeddings to dissimilar objects.

According to an embodiment, the sensed information unit is a cropped sensed information unit.

According to an embodiment there is provided a method for travel lane feature classification, comprising: obtaining, via a processing circuit, information indicative of a travel lane including one or more travel lane features located within a vehicle environment; generating a plurality of keypoints from the information; organizing the plurality of keypoints into one or more subgroups of keypoints, wherein each of the one or more subgroups of keypoints is indicative of one or more categories of travel lane features; and classifying, based on the organizing step, the one or more organized subgroups of keypoints as indicative of a travel lane marker.

According to an embodiment, the obtaining step includes obtaining, by an imaging sensor, a field of view image of a viewable area including the vehicle environment.

According to an embodiment, the organizing step comprises clustering each of the one or more subgroups of keypoints according to one or more pre-determined aspect ratios.

According to an embodiment, the method includes cropping the clustered one or more subgroups of keypoints by: determining minimum shape dimensions of a shape bounding the clustered one or more subgroups of keypoints; and adding a lateral margin and vertical margin to the minimum shape dimensions.

According to an embodiment, the method includes rotating the cropped clustered one or more subgroups of keypoints to an upright position.

According to an embodiment, the method includes resizing the upright cropped clustered one or more subgroups of keypoints to a fixed size.

According to an embodiment, the organizing step comprises clustering the one or more subgroups of keypoints based on aspect ratios.

According to an embodiment, the organizing step comprises training a classifier to classify each of the one or more subgroups of keypoints based on the aspect ratios.

According to an embodiment, the method includes classifying, based on the organizing step, at least a second subgroup of keypoints as indicative of a road boundary.

According to an embodiment, the method includes classifying, based on the organizing step, at least a third subgroup of keypoints as indicative of an incidental marking.

According to an embodiment, there is provided a non-transitory computer readable medium for travel lane feature classification, the non-transitory computer readable medium stores instructions that once executed by an object classification system of the vehicle cause the travel lane feature classification system to: obtain information indicative of a travel lane including one or more travel lane features located within a vehicle environment; generate a plurality of keypoints from the information; organize the plurality of keypoints into one or more subgroups of keypoints, wherein each of the one or more subgroups of keypoints is indicative of one or more categories of travel lane features; and classify, based on the organizing step, the one or more organized subgroups of keypoints as indicative of a travel lane marker.

According to an embodiment, the obtaining step comprises obtaining, by an imaging sensor, a field of view image of a viewable area including the vehicle environment.

According to an embodiment, the organizing step comprises clustering each of the one or more subgroups of keypoints according to one or more pre-determined aspect ratios.

According to an embodiment, the travel lane feature classification system is further configured to: crop the clustered one or more subgroups of keypoints by determining minimum shape dimensions of a shape bounding the clustered one or more subgroups of keypoints; and add a lateral margin and vertical margin to the minimum shape dimensions.

According to an embodiment, the organizing step comprises clustering the one or more subgroups of keypoints based on aspect ratios.

According to an embodiment, the organizing step comprises training a classifier to classify each of the one or more subgroups of keypoints based on the aspect ratios.

According to an embodiment, the travel lane feature classification system is further configured to classify, based on the organizing step, at least a second subgroup of keypoints as indicative of a road boundary.

According to an embodiment there is provided a travel lane feature classification system of a vehicle, the travel lane feature classification system comprising: one or more processing circuits that comprise at least a part of an integrated circuit, the one or more processing circuits are configured to: obtain information indicative of a travel lane including one or more travel lane features located within a vehicle environment; generate a plurality of keypoints from the information; organize the plurality of keypoints into one or more subgroups of keypoints, wherein each of the one or more subgroups of keypoints is indicative of one or more categories of travel lane features; and classify, based on the organizing step, the one or more organized subgroups of keypoints as indicative of a travel lane marker.

According to an embodiment, the organizing step comprises clustering each of the one or more subgroups of keypoints according to one or more pre-determined aspect ratios.

According to an embodiment, the travel lane feature classification system is further configured to: crop the clustered one or more subgroups of keypoints by determining minimum shape dimensions of a shape bounding the clustered one or more subgroups of keypoints; and add a lateral margin and vertical margin to the minimum shape dimensions.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any combination of any module or unit listed in any of the figures, any part of the specification and/or any claims may be provided.

Any one of transformation module, active learning module, or clustering module, or any other module described herein, may be implemented in hardware and/or code, instructions and/or commands stored in a non-transitory computer readable medium, may be included in a vehicle, outside a vehicle, in a mobile device, in a server, and the like.

The vehicle may be any type of vehicle—such as a ground transportation vehicle, an airborne vehicle, and a water vessel.

The specification and/or drawings may refer to an image. An image is an example of a media unit. Any reference to an image may be applied mutatis mutandis to a media unit. A media unit may be an example of sensed information. Any reference to a media unit may be applied mutatis mutandis to any type of natural signal such as but not limited to signal generated by nature, signal representing human behavior, signal representing operations related to the stock market, a medical signal, financial series, geodetic signals, geophysical, chemical, molecular, textual and numerical signals, time series, and the like. Any reference to a media unit may be applied mutatis mutandis to sensed information. The sensed information may be of any kind and may be sensed by any type of sensors-such as a visual light camera, an audio sensor, a sensor that may sense infrared, radar imagery, ultrasound, electro-optics, radiography, LIDAR (light detection and ranging), etc. The sensing may include generating samples (for example, pixel, audio signals) that represent the signal that was transmitted, or otherwise reach the sensor.

The specification and/or drawings may refer to a spanning element. A spanning element may be implemented in software or hardware. Different spanning element of a certain iteration are configured to apply different mathematical functions on the input they receive. Non-limiting examples of the mathematical functions include filtering, although other functions may be applied.

The specification and/or drawings may refer to a concept structure. A concept structure may include one or more clusters. Each cluster may include signatures and related metadata. Each reference to one or more clusters may be applicable to a reference to a concept structure.

The specification and/or drawings may refer to a processor. The processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

Any reference to an object may be applicable to a pattern. Accordingly—any reference to object detection is applicable mutatis mutandis to a pattern detection.

A situation may be a singular location/combination of properties at a point in time. A scenario is a series of events that follow logically within a causal frame of reference. Any reference to a scenario should be applied mutatis mutandis to a situation.

The sensed information unit may be sensed by one or more sensors of one or more types. The one or more sensors may belong to the same device or system—or may belong to different devices of systems.

A perception unit may be provided and may be preceded by the one or more sensors and/or by one or more interfaces form receiving one or more sensed information units. The perception unit may be configured to receive a sensed information unit from an I/O interface and/or from a sensor. The perception unit may be followed by multiple narrow AI agents—also referred to an ensemble of narrow AI agents.

A sensed information unit may or may not be processed before reaching the perception unit. Any processing may be providing—filtering, noise reduction, and the like.

We claim:

1. A method for travel lane element classification, comprising:
obtaining, via a processing circuit, information indicative of a travel lane including one or more travel lane elements located within an environment of a vehicle;
generating a plurality of keypoints from the information;
organizing the plurality of keypoints into one or more subgroups of keypoints, wherein each of the one or more subgroup of keypoints is indicative of one or more categories of travel lane elements;
generating one or more embeddings of the one or more subgroup of keypoints; and
classifying, based on the one or more embeddings, the one or more organized subgroup of keypoints as indicative of a travel lane marker;
wherein the classifying triggers a determination of a driving related operation to be executed by the vehicle.

2. The method according to claim 1, further comprising generating one or more signatures of the one or more embeddings, the one or more signatures are of higher dimensionality that the one or more embeddings, wherein the classifying is based on the one or more signatures.

3. The method according to claim 1, wherein the information indicative of the travel lane is a sensed information unit, wherein the method further comprises generating one or more cropped sensed information units, one cropped information unit per subgroup of keypoints.

4. The method according to claim 3, wherein the one or more embeddings are generated based on the one or more cropped sensed information unit.

5. The method of claim 1, wherein the obtaining step comprises obtaining, by an imaging sensor, a field of view image of a viewable area including the vehicle environment.

6. The method of claim 1, wherein the organizing step comprises clustering each of the one or more subgroup of keypoints according to one or more pre-determined aspect ratios.

7. The method of claim 6, further comprising cropping the clustered one or more subgroup of keypoints by:
determining minimum shape dimensions of a shape bounding the clustered one or more subgroup of keypoints; and
adding a lateral margin and vertical margin to the minimum shape dimensions.

8. The method of claim 7, further comprising rotating the cropped clustered one or more subgroup of keypoints to an upright position.

9. The method of claim 8, further comprising resizing the upright cropped clustered one or more subgroup of keypoints to a fixed size.

10. The method of claim 1, wherein the organizing step comprises clustering the one or more subgroup of keypoints based on aspect ratios.

11. The method of claim 1, wherein the organizing step comprises training a classifier to classify each of the one or more subgroup of keypoints based on the aspect ratios.

12. The method of claim 11, further comprising classifying, based on the organizing step, at least a second subgroup of keypoints as indicative of a road boundary.

13. The method of claim 12, further comprising classifying, based on the organizing step, at least a third subgroup of keypoints as indicative of an incidental marking.

14. A non-transitory computer readable medium for travel lane element classification, the non-transitory computer readable medium stores instructions that once executed by an object classification system of the vehicle cause the travel lane element classification system to:
obtain information indicative of a travel lane including one or more travel lane elements located within an environment of a vehicle;
generate a plurality of keypoints from the information;
organize the plurality of keypoints into one or more subgroup of keypoints, wherein each of the one or more subgroup of keypoints is indicative of one or more categories of travel lane elements;
generate one or more embeddings of the one or more subgroup of keypoints; and
classifying, based on the one or more embeddings, the one or more organized subgroup of keypoints as indicative of a travel lane marker

15. The non-transitory computer readable medium according to claim 14, further comprising generating one or more signatures of the one or more embeddings, the one or more signatures are of higher dimensionality that the one or more embeddings, wherein the classifying is based on the one or more signatures.

16. The non-transitory computer readable medium according to claim 14, wherein the information indicative of the travel lane is a sensed information unit, wherein the non-transitory computer readable medium further stores instructions for generating one or more cropped sensed information units, one cropped information unit per subgroup of keypoints.

17. The non-transitory computer readable medium according to claim 16, wherein the one or more embeddings age generated based on the one or more cropped sensed information unit.

18. The non-transitory computer readable medium of claim 11, wherein the organizing step comprises clustering each of the one or more subgroup of keypoints according to one or more pre-determined aspect ratios.

19. The non-transitory computer readable medium of claim 18, wherein the travel lane element classification system is further configured to:
crop the clustered one or more subgroup of keypoints by determining minimum shape dimensions of a shape bounding the clustered one or more subgroup of keypoints; and
add a lateral margin and vertical margin to the minimum shape dimensions.

20. A travel lane element classification system of a vehicle, the travel lane element classification system comprising:
a processing circuit that is configured to:
obtain information indicative of a travel lane including one or more travel lane elements located within a vehicle environment;
generate a plurality of keypoints from the information;
organize the plurality of keypoints into one or more subgroup of keypoints, wherein each of the one or more subgroup of keypoints is indicative of one or more categories of travel lane elements;
generate one or more embeddings of the one or more subgroup of keypoints; and
classify, based on the one or more embeddings, the one or more organized subgroup of keypoints as indicative of a travel lane marker.
